(19) United States
(12) Patent Application Publication
(10) Pub. No.: US 2026/0263849 A1
(43) Pub. Date: Sep. 10, 2026

(54) FIRE PREVENTION ASSEMBLY AND METHOD FOR FIRE PREVENTION IN ELECTRONICS

(71) Applicant: HL MANDO CORPORATION, Gyeonggi-do (KR)

(72) Inventor: Seonkyu SEO, Auburn, MI (US)

(21) Appl. No.: 19/457,873

(22) Filed: Jan. 23, 2026

Related U.S. Application Data
(60) Provisional application No. 63/767,516, filed on Mar. 5, 2025.

(51) Int. Cl. A62C 3/07; B60R 21/01; H02H 5/04

(52) U.S. Cl. CPC A62C 3/07; B60R 21/01; H02H 5/042; H02H 5/047; B60R 2021/01286

(57) ABSTRACT

A fire prevention assembly for an electronic control unit (ECU) is provided. The fire prevention assembly includes: a forced overcurrent circuit that is adapted to forcibly cause an overcurrent to occur at a thermal fuse circuit of the ECU; and a temperature sensor that triggers the forced overcurrent circuit to forcibly cause the overcurrent to occur at the thermal fuse circuit, the overcurrent causing the thermal fuse circuit to disconnect the ECU from a power source of the ECU.

### CROSS REFERENCE TO PARENT APPLICATIONS

This application claims the benefit of U.S. Patent Application Serial No. 63/767,516 filed on Mar. 5, 2025, entitled “THERMAL FUSE OPERATION AND FIRE PREVENTION USING THERMISTOR”, the entirety of which is incorporated herein by reference.

### BACKGROUND

Various embodiments of the present disclosure relate in general to assemblies (e.g., systems, apparatuses, and/or devices) for preventing fires in electronics (e.g., electronic control units (ECUs), or the like). In particular, faults (e.g., overcurrent, overload, short circuits, ground faults, or the like) can cause components within ECUs and other such electronics to heat and burn up, causing fires within systems (e.g., vehicles, computing devices, etc.) in which such ECUs are installed. Such fires could lead to dangerous explosions when occurring in close proximity to one or more power sources (e.g., batteries or the like) within these systems.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiment of the present disclosure, a fire prevention assembly for an electronic control unit (ECU) may comprise: a forced overcurrent circuit that is adapted to forcibly cause an overcurrent to occur at a thermal fuse circuit of the ECU; and a temperature sensor that triggers the forced overcurrent circuit to forcibly cause the overcurrent to occur at the thermal fuse circuit, the overcurrent causing the thermal fuse circuit to disconnect the ECU from a power source of the ECU.

The temperature sensor is a thermistor, and the thermistor triggers the forced overcurrent circuit to forcibly cause the overcurrent to occur at the thermal fuse circuit when a temperature of the thermistor exceeds a predetermined temperature threshold.

The forced overcurrent circuit comprises a charge pump and a switch.

The switch comprises two bipolar junction transistors.

The thermistor triggers the switch to connect the charge pump to the thermal fuse circuit for the charge pump to provide the overcurrent to the thermal fuse circuit.

The thermal fuse circuit comprises a Metal-Oxide-Semiconductor Field-Effect Transistor (MOSFET) and a thermal fuse.

The charge pump is adapted to apply a voltage at a gate of the MOSFET to cause the MOSFET to overheat and trigger the thermal fuse to switch from a closed state to an open state, the open state disconnecting the ECU from the power source.

The voltage applied by the charge pump is at least 10V higher than an existing voltage across the gate of the MOSFET.

The thermistor detects when overheating occurs within components disposed within a housing of the ECU as a result of a second overcurrent flowing through the components, the overheating of the components occurring at a position within the housing of the ECU that is undetectable by the thermal fuse circuit.

The fire prevention assembly comprises a plurality of thermistors, the thermistor being one of the thermistors.

According to various embodiment of the present disclosure, a method for fire prevention within an electronic control unit (ECU) using a fire prevention assembly installed within the ECU may comprise: detecting, by a temperature sensor, that a temperature within the ECU has exceeded a predetermined threshold; causing, by the temperature sensor, a forced overcurrent circuit to forcibly cause an overcurrent to occur at a thermal fuse circuit of the ECU; and disconnecting, by the thermal fuse circuit and upon the overcurrent being forcibly caused to occur at the thermal fuse circuit, the ECU from a power source of the ECU, the temperature sensor and the forced overcurrent circuit making up the fire prevention assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a fire prevention assembly according to an exemplary embodiment of the present disclosure.

FIG. 2 shows a flowchart for a fire prevention method using the fire prevention assembly of FIG. 1 according to an exemplary embodiment of the present disclosure.

FIG. 3 shows a schematic view of a vehicle in which the fire prevention assembly of FIG. 1 is installed according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

References to an “operable connection” or “operably connected” means that a particular device is able to communicate (e.g., send and receive data or the like) with one or more other devices. The devices themselves may be directly connected to one another or may be indirectly connected to one another through any number of intermediary devices, such as in a network topology. The connections between the devices may be wired and/or wireless connections.

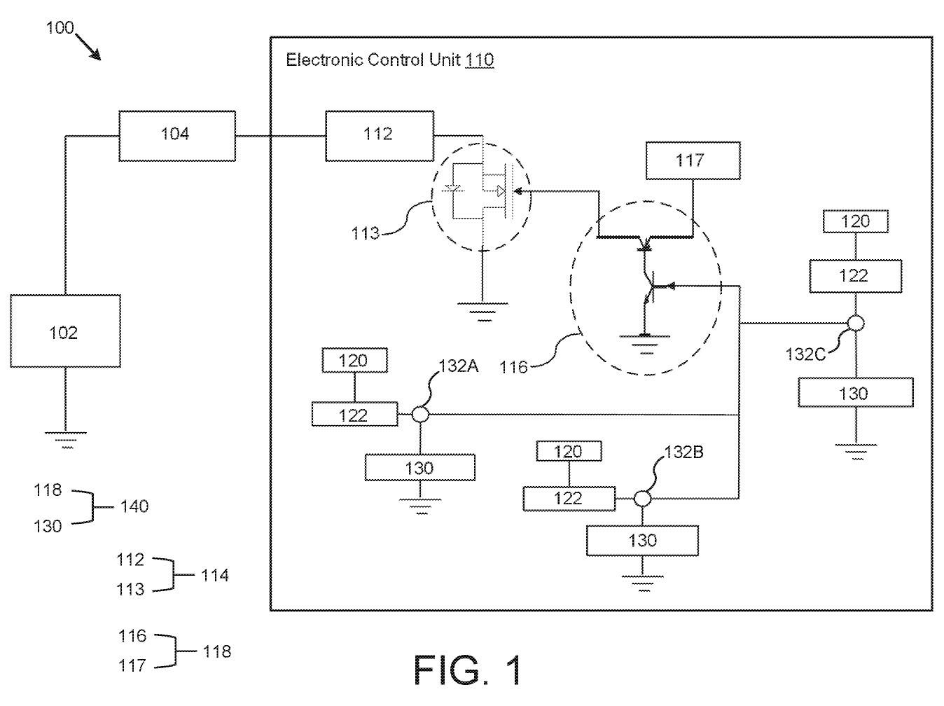

Starting with FIG. 1, FIG. 1 shows an environment 100 in which a fire prevention assembly 140 of embodiments disclosed herein could be installed (i.e., disposed). In particular, environment 100 may include an electronic control unit (ECU) 110 that is connected to a power source 102 and an electrical safety device 104. For example, in the context of a vehicle (e.g., a car, or the like), the electronic control unit 110 may be an embedded system in automotive electronics that controls one or more of the electrical systems or subsystems installed within the vehicle (e.g., an engine control module (ECM), powertrain control module (PCM), transmission control module (TCM), brake control module (BCM or EBCM), central control module (CCM), central timing module (CTM), general electronic module (GEM), body control module (BCM), suspension control module (SCM), or the like). The power source 102 may be a vehicle battery, and the electrical safety device 104 may be a vehicle fuse (or the like).

Although embodiments disclosed herein will be described mainly in the context of vehicles (namely, motor vehicles), embodiments disclosed herein are not limited to just the context of motor vehicles and can be applied to other contexts and/or environments (e.g., in computing devices such as laptops, servers, tables, desktop computers, or the like in which one or more forms of ECUs (e.g., motherboards, computer chips, embedded systems, embedded controllers, or the like) can be installed) without departing from the scope of embodiments disclosed herein.

Turning back to FIG. 1, ECU 110 may include various voltage sources 120 (e.g., a voltage common collector (VCC) or the like) that supply power received from the vehicle battery (i.e., power source 102) (or a different power source) to components within the ECU 110. These voltage sources 120 may be electrically connected to one or more electrical components 122 (e.g., resistors, capacitors, transistors, microchips, or the like). Although only a single electrical component 122 is shown to be connected to each voltage source 120 in FIG. 1, one of ordinary skill in the art would appreciate that multiple electrical components 122 (e.g., making up one or more circuits) may be connected to each voltage source 120 without departing from the scope of embodiments disclosed herein.

To protect the electrical components 122 (e.g., from overheating, or the like), the ECU 110 includes a thermal fuse circuit 114. The thermal fuse circuit 114 may include a thermal fuse 112 (or other similar electrical safety device such as other types of fuses or the like) and a Metal-Oxide-Semiconductor Field-Effect Transistor (MOSFET) 113. The properties (e.g., rating, type, spec, or the like) of the thermal fuse circuit 114 and MOSFET 113 may be based on, but not limited to: (i) environment in which ECU 110 is installed; (ii) manufacturer design preferences and/or needs; (iii) the nature and properties of the other electrical components within the ECU including how the other electrical components operate; or the like.

To prevent fires (e.g., fires caused by one or more of the components 122 burning up, or the like) from starting within ECU 110, the ECU 110 includes (e.g., installed within) fire prevention assembly 140 of embodiments disclosed herein. The fire prevention assembly 140 may include one or more temperature sensors 130 and a forced overcurrent circuit 118.

Each of the temperature sensors 130 could be implemented using a thermistor. Each of the temperature sensors 130 may also be any other electrical component or combination of electrical components that could detect and react to a change in temperature of electrical components 122. Any type of thermistor (and/or other type of temperature sensing electrical component) can be used, and the type and properties of the temperature sensor 130 selected may depend on, but is not limited to: (i) environment in which ECU 110 is installed; (ii) manufacturer design preferences and/or needs; (iii) the nature and properties of the other electrical components within the ECU including how the other electrical components operate; or the like.

In embodiments, the type of thermistor (and/or other type of temperature sensing electrical component) may be selected based on a maximum acceptable temperature threshold (e.g., a predetermined temperature threshold, or the like) set by a manufacturer of ECU 110. The maximum acceptable temperature may be based on the temperature characteristics and ratings of each of the electrical components 122 (namely, a temperature under the maximum temperature rating of one or more of the electrical components 122) and may be chosen to prevent the temperature of any of the electrical components 122 from reaching a point where one or more of the electrical components 122 are at risk of burning up and causing a fire within ECU 110.

Based on the electrical components 122 that a temperature sensor 130 is installed next to, each of the temperature sensors 130 may have a different maximum acceptable temperature threshold. In particular, each temperature sensor 130 could be configured to monitor a temperature at a designated temperature point 132A, 132B, 132C within the ECU 110. Each temperature sensor 130 could also be placed at a distance (e.g., a manufacturer determined and/or designed distance) from the electrical components 122 at which the temperature sensor 130 is best able to detect and react to a sudden change in the temperature of the electrical components 122 (e.g., as a result of one or more faults occurring within the ECU 110).

Each of the temperature sensors 130 may also be selectively positioned in areas (e.g., positions) within the ECU 110 where electrical component(s) 122 could heat up without being detected by the components of the thermal fuse circuit 114. For example, the thermal fuse circuit only operates when overcurrent (or the like) flows through nearby electrical component(s) 122. When overcurrent (or the like) flows through electrical component(s) 122 that are positioned distant (e.g., far away) from the thermal fuse circuit 114, the rise in temperature within these distance electrical component(s) 122 may not reach the thermal fuse circuit 114 at all (preventing the thermal fuse circuit 114 from activating) or may only reach the thermal fuse circuit 114 when it is too late and the heated up electrical component(s) 122 have already started to burn.

Said another way, designated temperature points 132A, 132B, 132C are chosen (e.g., as positions within the housing of the ECU 110 at which rises in temperature potentially undetectable or less detectable by the thermal fuse circuit) to ensure that such distant electrical component(s) 122 do not overheat and burn up before the thermal fuse circuit 114 can be activated to cut off power (e.g., from vehicle battery (i.e., power source 102)) to the ECU 110. Thus, not only can the number of thermal fuse circuits 114 be reduced within the ECU 110 (e.g., to reduce the costs of each ECU 110, to provide more space for other electrical components, or the like), the package size (e.g., housing size) of the ECU 110 can also be advantageously increased without the fear of any of the electrical component(s) from heating and burning up before the thermal fuse circuit 114 can be activated (namely, by the fire prevention assembly 140 of embodiments disclosed herein).

In embodiments, the forced overcurrent current circuit 118 may include a switch 116 and a charge pump 117. Under normal operating conditions of the ECU 110 (i.e., a state in which none of the electrical component(s) 122 are overheating and the thermal fuse circuit 114 does not need to be activated to prevent a fire from starting within ECU 110), the switch 116 is configured to be in an open state such that the charge pump 117 is not electrically connected to any components of the thermal fuse circuit 114.

As shown in FIG. 1, the switch 116 is implemented using two bipolar junction transistors (BJTs) (e.g., that come in the form of a single package, or the like). However, embodiments disclosed herein are not limited to such a configuration and other types of electrical components (e.g., MOSFETs, switches, or the like) may be used as the switch 116 depending on factors such as, but not limited to: (i) environment in which ECU 110 is installed; (ii) manufacturer design preferences and/or needs; (iii) the nature and properties of the other electrical components within the ECU including how the other electrical components operate; or the like.

The charge pump 117 can be configured to produce a voltage (or the like) (also referred to herein as a “forced overcurrent”) that would cause the thermal fuse circuit 114 to disconnect (e.g., trip) and cut power (e.g., from vehicle battery (i.e., power source 102)) to the ECU 110. For example, in the context of FIG. 1 where thermal fuse circuit 114 contains MOSFET 113, assume that the normal operating voltage across a gate of the MOSFET 113 is X volts. The charge pump 117 may be configured to produce a voltage that is 10 volts (10V), or more, higher than this normal operating voltage of the MOSFET 113 to force the MOSFET 113 to overheat and trip the thermal fuse 112 (resulting in the thermal fuse 112 to electrically disconnect ECU 110 from the vehicle battery (i.e., power source 102)). The voltage produced by the charge pump 117 may be set to a value determined by the manufacturer of ECU 110 as a value that could cause the MOSFET 113 to overheat in the least amount of time (or the like) in order to be able to trip the thermal fuse 112 in the fastest time possible to prevent one or more of the electrical components 122 from burning up.

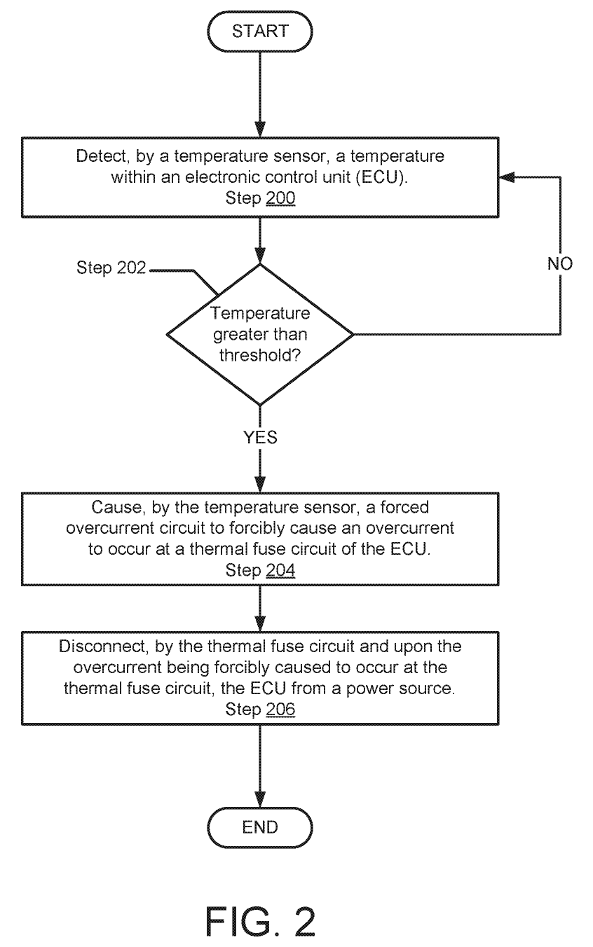

Although specific components (e.g., MOSFET 113, BJTs making up switch 116, charge pump 117, switch 116, etc.) and combination of components (e.g., the MOSFET 113 and thermal fuse 112 combination, or the like) are described above, one of ordinary skill in the art would appreciate that different components and/or combination of components can make up each circuit (e.g., the thermal fuse circuit 114, the forced overcurrent circuit 118, or the like) based on not only different requirements and needs of different manufacturers and/or designers of the ECU 110 but also the environment (e.g., a vehicle environment, a computing device environment, or the like) in which the ECU 110 is installed. Said another way, any equivalents (or even completely different types of components) of any of the components discussed above in FIG. 1 may be used without departing from the scope of embodiments disclosed herein as along as the same effect of the fire prevention method (discussed in Step 200 through Step 206 below in refernce to FIG. 2) is achieved.

Additionally, existing components within ECUs (e.g., the charge pump 117 in vehicle-based ECUs) may be leveraged as part of the fire prevention assembly 140 of embodiments disclosed herein without the addition of additional and/or different components that are configured to provide the same functions (e.g., the forced overcurrent generation functions) as the existing components.

Turning now to FIG. 2, FIG. 2 shows a flowchart detailing a method for preventing fires within the ECU 110 of FIG. 1 using the fire prevention assembly 140 of embodiments disclosed herein.

In particular, starting at Step 200, a temperature sensor (e.g., of temperature sensors 130) within the ECU 110 detects a temperature within the ECU 110. The temperature being detected may be the temperature at any of the designated temperature points 132A, 132B, 132C.

At Step 202, if the detected temperature (e.g., at designated temperature point 132A as a non-limited example) exceeds the maximum acceptable temperature threshold (e.g., a YES scenario at Step 202, the process proceeds to Step 204. Otherwise (e.g., a NO scenario at Step 202), the temperature sensor will do nothing and continue to detect and monitor the temperature at designated temperature point 132A (e.g., the process returns to Step 200).

At Step 204, the temperature sensor (e.g., the temperature sensor 130 in charge of detecting and monitoring the temperature at designated temperature point 132A) triggers (i.e., causes) forced overcurrent circuit 118 to forcibly cause an overcurrent to occur at the thermal fuse circuit 114 of the ECU 110.

For example, and as discussed above in refence to FIG. 1, the temperature sensor (e.g., a thermistor) may cause the switch 116 of forced overcurrent circuit 118 to allow (i.e., causes the switch to transition from an open state to a closed state where the switch 116 now electrically connects charge pump 117 with MOSFET 113) the forced overcurrent produced by charge pump 117 of forced overcurrent circuit 118 to be fed to MOSFET 113 of the thermal fuse circuit 114.

As a result of the forced overcurrent being fed to MOSFET 113, the MOSFET is (i.e., at Step 206) intentionally (e.g., forcibly) overheated to cause the thermal fuse to be tripped (i.e., disconnected), which cuts off external power from the vehicle battery (i.e., power source 102) to the ECU 110. Once the power is cutoff to the ECU 110, the overcurrent (or the like) occurring at electrical component(s) 122 at designated temperature point 132A is eliminated, which stops the electrical component(s) 122 at designated temperature point 132A from continuing to heat up (i.e., allows the electrical component(s) 122 to start to cool down) and effectively preventing any fires from being started by any of the electrical component(s) 122 at designated temperature point 132A.

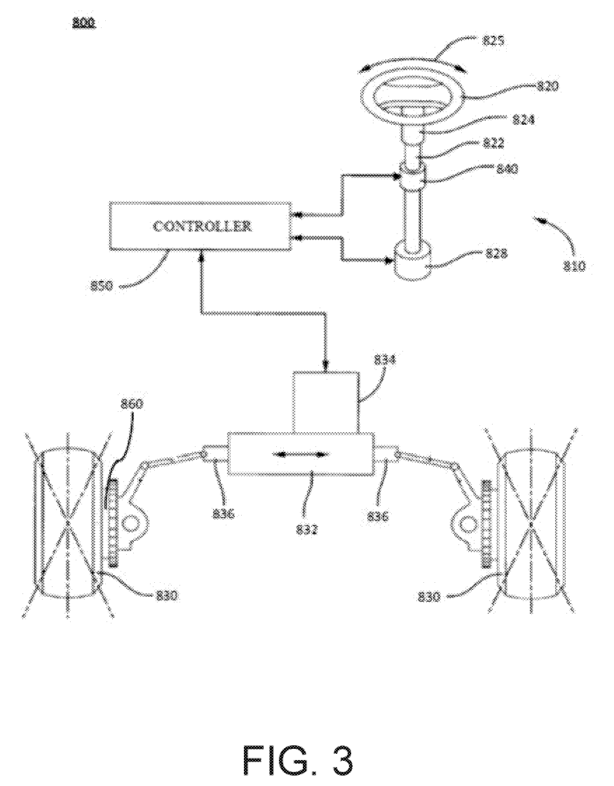

Any motor vehicles discussed in refernce to FIGS. 1 and 2 may be identical, or substantially similar to, vehicle 800 shown in FIG. 3. The vehicle 800 may be any passenger or commercial automobile such as a hybrid vehicle, an electric vehicle, or any other type vehicles. FIG. 3 is a schematic view of a vehicle 800 including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820. Controller 850 may be a chassis controller of the vehicle 800. The chassis controller may be implemented using one or more of the ECUs 110 of FIG. 1. Although not shown in FIG. 3, other components within the vehicle (e.g., the brakes/brake assemblies, or the like) that are implemented in hybrid form (e.g., part mechanical and part electronic systems such as electromechanical systems or the like) may also include their own ECUs (e.g., ECU 110 of FIG. 1).

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 3 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

The electric motor can also be employed in an electromagnetic brake assembly 860. The electromagnetic brake assembly 860 is configured to cause the road wheel 830 to slow or stop motion using electromagnetic force to apply mechanical resistance or friction by using the torque generated by the electric motor.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A fire prevention assembly for an electronic control unit (ECU), the fire prevention assembly comprising:
a forced overcurrent circuit that is adapted to forcibly cause an overcurrent to occur at a thermal fuse circuit of the ECU; and
a temperature sensor that triggers the forced overcurrent circuit to forcibly cause the overcurrent to occur at the thermal fuse circuit, the overcurrent causing the thermal fuse circuit to disconnect the ECU from a power source of the ECU.

2. The fire prevention assembly of claim 1, wherein the temperature sensor is a thermistor, and the thermistor triggers the forced overcurrent circuit to forcibly cause the overcurrent to occur at the thermal fuse circuit when a temperature of the thermistor exceeds a predetermined temperature threshold.

3. The fire prevention assembly of claim 2, wherein the forced overcurrent circuit comprises a charge pump and a switch.

4. The fire prevention assembly of claim 3, wherein the switch comprises two bipolar junction transistors.

5. The fire prevention assembly of claim 4, wherein the thermistor triggers the switch to connect the charge pump to the thermal fuse circuit for the charge pump to provide the overcurrent to the thermal fuse circuit.

6. The fire prevention assembly of claim 3, wherein the thermal fuse circuit comprises a Metal-Oxide-Semiconductor Field-Effect Transistor (MOSFET) and a thermal fuse.

7. The fire prevention assembly of claim 6, wherein the charge pump is adapted to apply a voltage at a gate of the MOSFET to cause the MOSFET to overheat and trigger the thermal fuse to switch from a closed state to an open state, the open state disconnecting the ECU from the power source.

8. The fire prevention assembly of claim 7, wherein the voltage applied by the charge pump is at least 10V higher than an existing voltage across the gate of the MOSFET.

9. The fire prevention assembly of claim 2, wherein the thermistor detects when overheating occurs within components disposed within a housing of the ECU as a result of a second overcurrent flowing through the components, the overheating of the components occurring at a position within the housing of the ECU that is undetectable by the thermal fuse circuit.

10. The fire prevention assembly of claim 9, wherein the fire prevention assembly comprises a plurality of thermistors, the thermistor being one of the thermistors.

11. A method for fire prevention within an electronic control unit (ECU) using a fire prevention assembly installed within the ECU, the method comprising:
detecting, by a temperature sensor, that a temperature within the ECU has exceeded a predetermined threshold;
causing, by the temperature sensor, a forced overcurrent circuit to forcibly cause an overcurrent to occur at a thermal fuse circuit of the ECU; and
disconnecting, by the thermal fuse circuit and upon the overcurrent being forcibly caused to occur at the thermal fuse circuit, the ECU from a power source of the ECU, the temperature sensor and the forced overcurrent circuit making up the fire prevention assembly.

12. The method of claim 11, wherein the temperature sensor is a thermistor, and the thermistor triggers the forced overcurrent circuit to forcibly cause the overcurrent to occur at the thermal fuse circuit when a temperature of the thermistor exceeds a predetermined temperature threshold.

13. The method of claim 12, wherein the forced overcurrent circuit comprises a charge pump and a switch.

14. The method of claim 13, wherein the switch comprises two bipolar junction transistors.

15. The method of claim 14, wherein the thermistor triggers the switch to connect the charge pump to the thermal fuse circuit for the charge pump to provide the overcurrent to the thermal fuse circuit.

16. The method of claim 13, wherein the thermal fuse circuit comprises a Metal-Oxide-Semiconductor Field-Effect Transistor (MOSFET) and a thermal fuse.

17. The method of claim 16, wherein the charge pump is adapted to apply a voltage at a gate of the MOSFET to cause the MOSFET to overheat and trigger the thermal fuse to switch from a closed state to an open state, the open state disconnecting the ECU from the power source.

18. The method of claim 17, wherein the voltage applied by the charge pump is at least 10V higher than an existing voltage across the gate of the MOSFET.

19. The method of claim 12, wherein the thermistor detects when overheating occurs within components disposed within a housing of the ECU as a result of a second overcurrent flowing through the components, the overheating of the components occurring at a position within the housing of the ECU that is undetectable by the thermal fuse circuit.

20. The method of claim 19, wherein the fire prevention assembly comprises a plurality of thermistors, the thermistor being one of the thermistors.
